(19) United States
(12) Patent Application Publication
(10) Pub. No.: US 2015/0195390 A1
(43) Pub. Date: Jul. 9, 2015

(54) Separable Mobile Communication Device and Method

(71) Applicant: Sheng-Chun Lin, New Taipei City (TW)

(72) Inventor: Sheng-Chun Lin, New Taipei City (TW)

(21) Appl. No.: 14/150,769

(22) Filed: Jan. 9, 2014

(51) Int. Cl. H04M 1/02; H04W 76/02; H04M 1/73

(52) U.S. Cl. CPC H04M 1/0254; H04M 1/73; H04W 76/02

(57) ABSTRACT

A separable mobile communication device and method are disclosed, including a carrier body, a first wireless receiving/transmitting device arranged in the carrier body, a separable device selectively mountable to the carrier body, and a second wireless receiving/transmitting device arranged in the separable device. The carrier body and the separable device are operable individually. The carrier body further includes a wireless communication module. To use, the separable device is separable from the carrier body for independent use and wireless information transmission may be achieved through the second wireless receiving/transmitting device and the first wireless receiving/transmitting device, so that information of the separable device and the carrier body can synchronized. The separable device is allowed to perform communication and network connection through the wireless communication module so as to allow for reduction of power consumption of the separable device.

### (a) TECHNICAL FIELD OF THE INVENTION

The present invention generally relates to a separable mobile communication device and method, and more particularly to a separable mobile communication device and method that allows for separation for individual use and transmission of information and also allows for free, convenient, and versatile ways of use and carrying.

### (b) DESCRIPTION OF THE PRIOR ART

Generally, a conventional mobile phone comprises a pushbutton section and a display section. Based on the connection relationship between the pushbutton section and the display section, the conventional mobile phones can be classified in two types, namely a unitary type and a foldable type. Although the main stream of design of the conventional mobile phones is compact and light-weighted for easy carrying and use by a user, the reduction of surface area in subjected to certain constraints for the conventional mobile phones. Over-reduction of the surface area of a conventional mobile phone would cause corresponding reduction of the pushbutton section, making the operation difficult and inconvenient. Further, reduction may also be applied to the display section and this causes difficult viewing of the user. Further, due to such a factor that the conventional mobile phone cannot be greatly reduced in the surface area thereof, the overall weight of the conventional mobile phone cannot be reduced either. This causes inconvenience for user in doing exercises.

It is thus a direction of improvement to be achieved by the present inventor and those working in the related industries in order to overcome the above discussed problems and drawbacks.

### SUMMARY OF THE INVENTION

Thus, the present invention aims to provide a separable mobile communication device and method that allows for separation for individual use and transmission of information and also allows for free, convenient, and versatile ways of use and carrying.

The primary object of the present invention is to make volume reduced and carrying easy by means of use in a separated fashion.

Another object of the present invention is to make information synchronized by means of transmission of information.

To achieve the above objects, the general structure of the present invention comprises a carrier body. The carrier body comprises a first power supply, a first computation module connected to the first power supply, a first input/output module connected to the first power supply, a first wireless receiving/transmitting device connected to the first power supply, a first wireless charging device connected to the first power supply, a first transmission device connected to the first power supply, and a wireless communication module connected to the first power supply. The carrier body receives a separable device to selectively mount thereto. The separable device comprises a second power supply, a second computation module connected to the second power supply, a second input/output module connected to the second power supply, a second wireless receiving/transmitting device connected to the second power supply, a second transmission device connected to the second power supply, a second wireless charging device connected to the second power supply, and a camera device connected to the second power supply. The second transmission device and the first transmission device are selectively connectable to each other. The second wireless receiving/transmitting device and the first wireless receiving/transmitting device are in wireless information connection with each other. In use of the present invention, the separable device and the carrier body can be separated from each other for operation and use so as to allow for easier carrying by a user. The separable device may perform wireless information transmission with the carrier body through the second wireless receiving/transmitting device and the first wireless receiving/transmitting device so that the information of the separable device can be synchronized with that of the carrier body. The separable device is allowed to perform communication or network connection through the wireless communication module of the carrier body so that, besides being easy to use, power consumption of the separable device can be reduced. With such arrangement, the problems of the conventional mobile phone of being difficult to carry resulting from it being difficult to reduce the surface area and the weight thereof can be overcome, and advantages of be separate for individual use and mutual transmission of information and allowing for free, convenient, and versatile ways of use and carrying can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is a block diagram of the preferred embodiment of the present invention.

FIG. 3A is a perspective view illustrating a use of the preferred embodiment of the present invention.

FIG. 3B is a perspective view illustrating another use of the preferred embodiment of the present invention.

FIG. 4 is a block diagram illustrating a use of the preferred embodiment of the present invention.

FIG. 5 is a perspective view showing another preferred embodiment of the present invention.

FIG. 6 is a block diagram of said another preferred embodiment of the present invention.

FIG. 7A is a perspective view illustrating a use of said another preferred embodiment of the present invention.

FIG. 7B is a perspective view illustrating another use of said another preferred embodiment of the present invention.

FIG. 7C is a perspective view illustrating a further use of said another preferred embodiment of the present invention.

FIG. 8 is a block diagram illustrating a user of said another preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

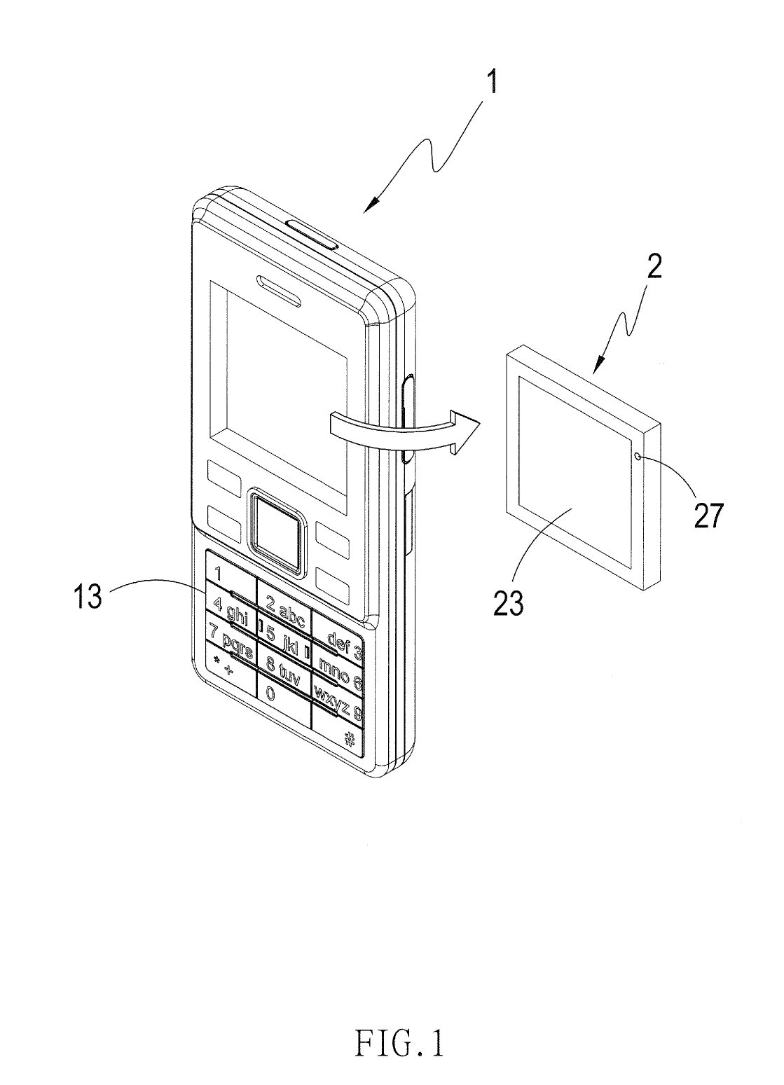

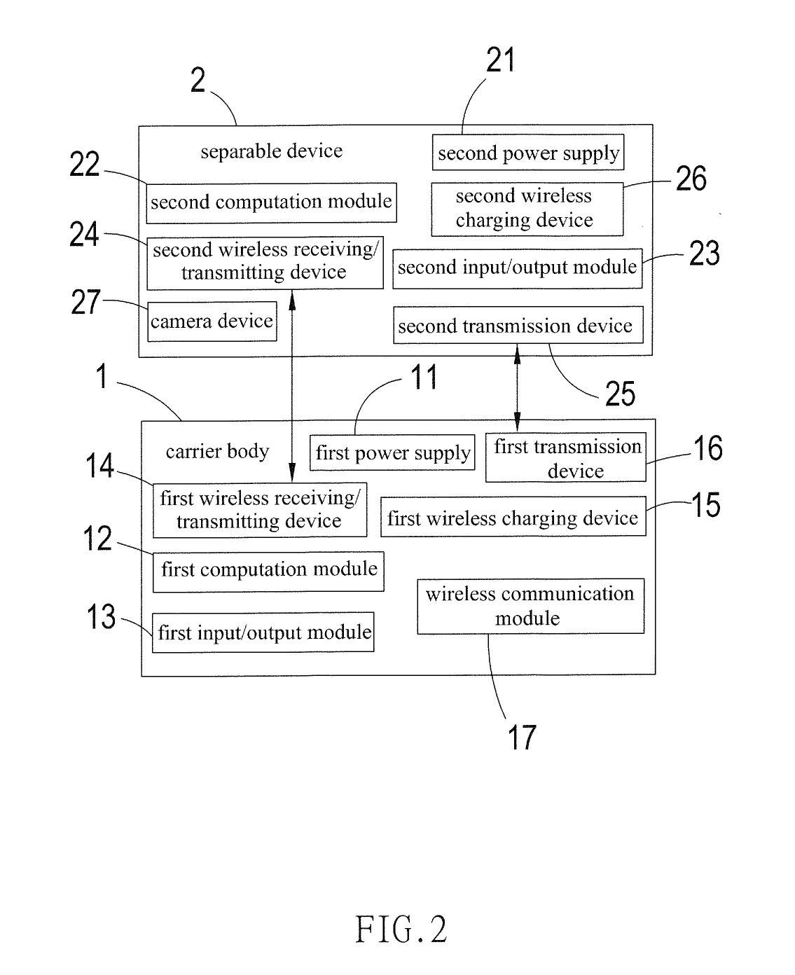

Referring to FIGS. 1 and 2, which are respectively a perspective view and a block diagram of a preferred embodiment of the present invention, these drawings clearly show that the present invention comprises a carrier body 1 and a separable device 2. The carrier body 1 comprises a first power supply 11, a first computation module 12 connected to the first power supply 11, a first input/output module 13 connected to the first power supply 11, a first wireless receiving/transmitting device 14 connected to the first power supply 11, a first wireless charging device 15 connected to the first power supply 11, a first transmission device 16 connected to the first power supply 11, and a wireless communication module 17 connected to the first power supply 11. The separable device 2 comprises a second power supply 21, a second computation module 22 connected to the second power supply 21, a second input/output module 23 connected to the second power supply 21, a second wireless receiving/transmitting device 24 connected to the second power supply 21, a second transmission device 25 connected to the second power supply 21, a second wireless charging device 26 connected to the second power supply 21, and a camera device 27 connected to the second power supply 21. The separable device 2 is selectively mountable to the carrier body 1. The second transmission device 25 and the first transmission device 16 are selectively connectable to each other and the second wireless receiving/transmitting device 24 and the first wireless receiving/transmitting device 14 are in wireless information connection with each other. The first wireless charging device 15 is set in wireless electrical connection with and electrically charges the second wireless charging device 26. The first input/output module 13 and the second input/output module 23 can each be a touch screen, a touch keypad, a screen, or a keypad or at least two of them (the first input/output module 13 being shown as a keypad, while the second input/output module 23 being a touch screen). Further, the above description is provided for just one of various embodiments of the present invention and the present invention is not limited to such an embodiment.

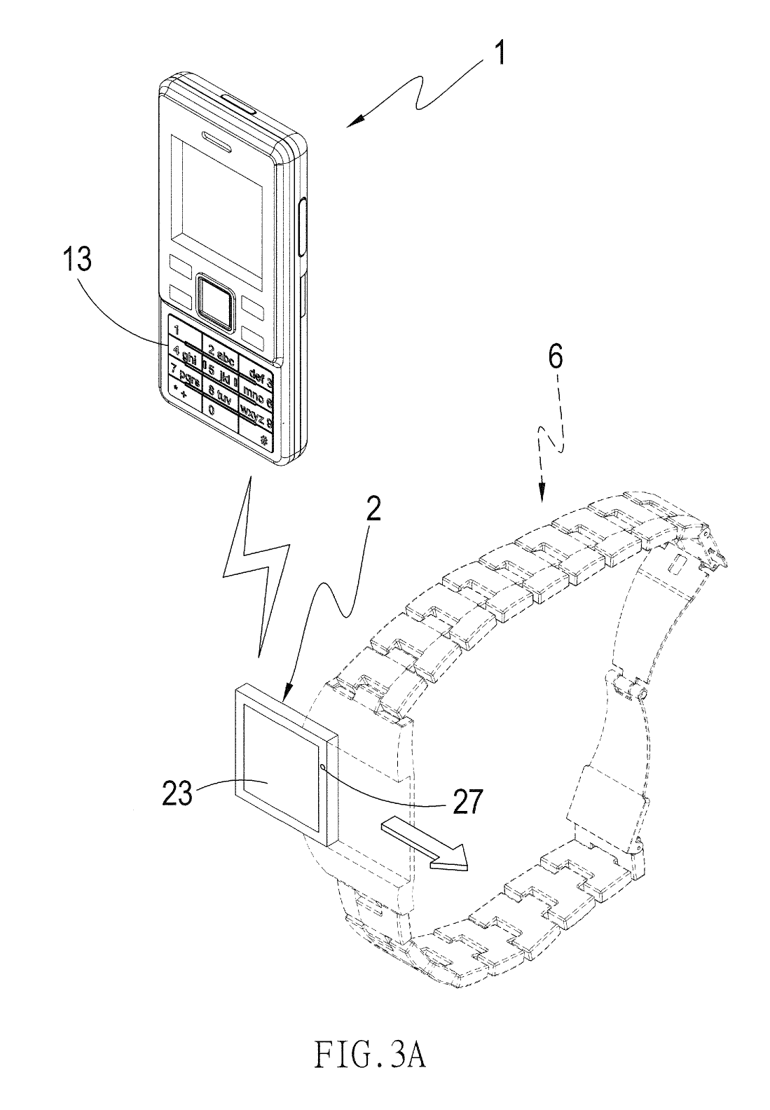

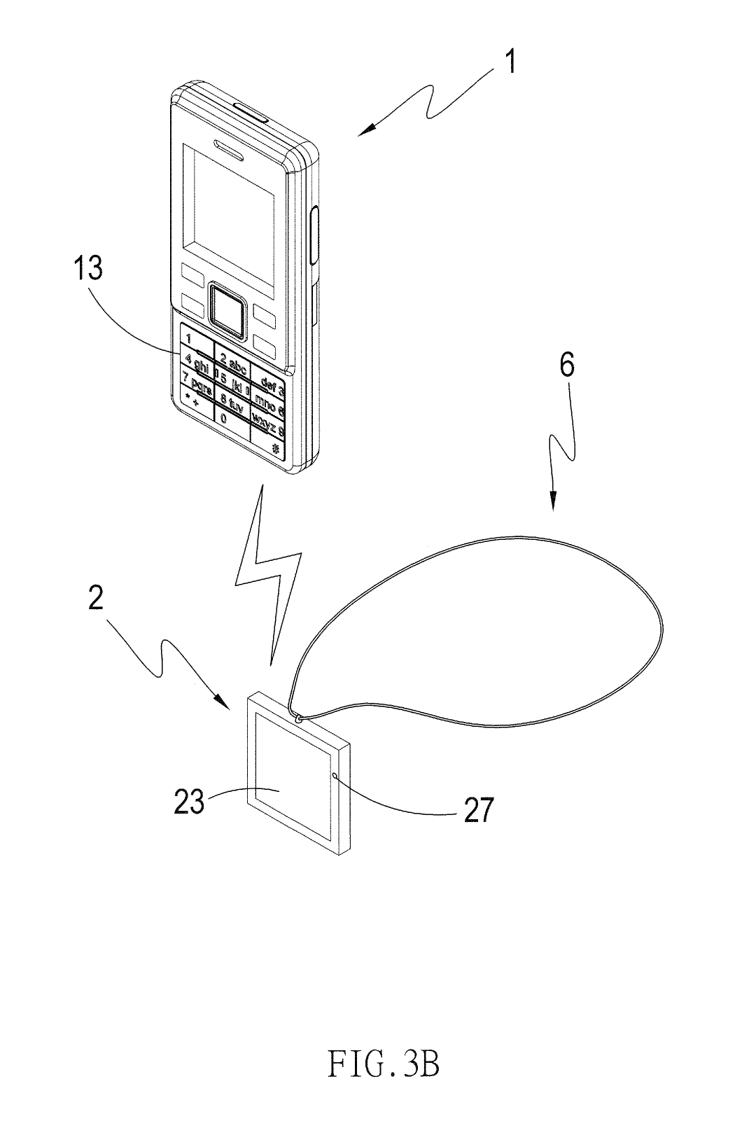

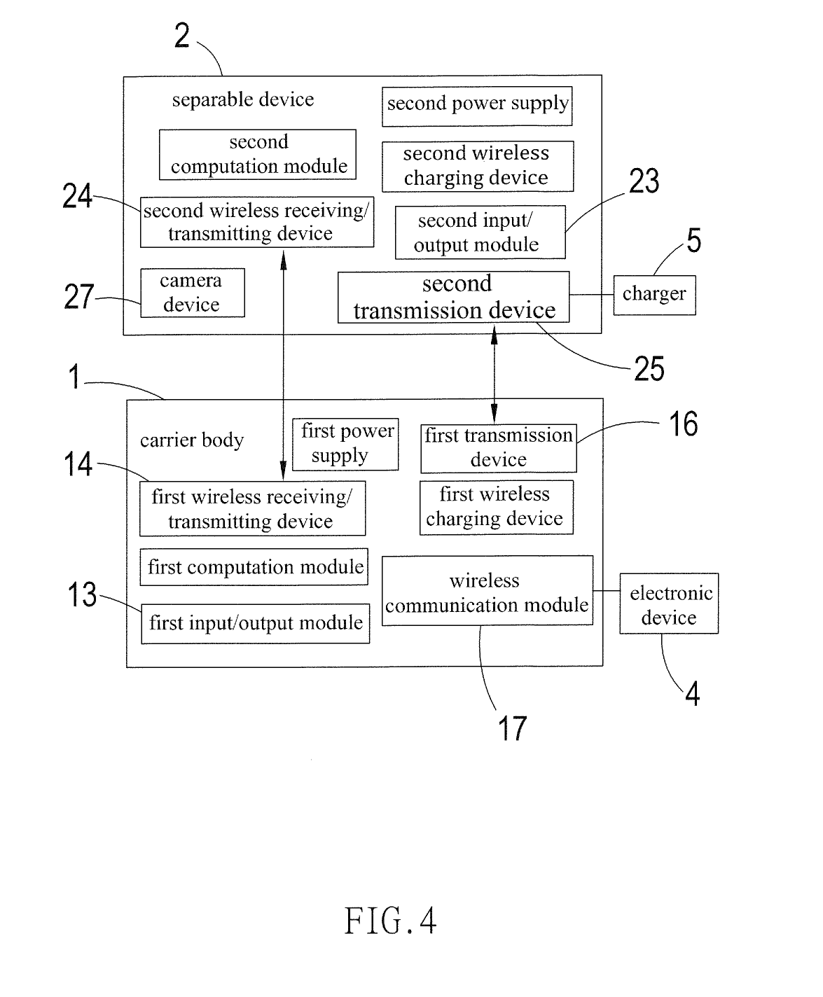

Referring to FIGS. 1-4, which are respectively a perspective view and a block diagram of the preferred embodiment of the present invention, perspective views showing two ways of use of the preferred embodiment of the present invention, and a block diagram showing a use of the preferred embodiment of the present invention, these drawings clearly show that in use, the present invention allows the separable device 2 to be mounted to the carrier body 1 so that the carrier body 1 and the separable device 2 transmit information through engagement established between the first transmission device 16 and the second transmission device 25, thereby allowing a user to use the entirety of the device, or alternatively, the separable device 2 and the carrier body 1 are separated from each other to allow for easy carrying by the user. Further, the separable device 2 can be coupled to a wearable member 6 for easer carrying. Further, the separable device 2 and the carrier body 1 can be individually operated through the first input/output module 13 and the second input/output module 23 thereof. For example, the second input/output module 23 can be used to operate the camera device 27 for photographing (as shown in FIGS. 3A and 3B). The information of the separable device 2 and the carrier body 1 can be transmitted in a wireless manner through the second wireless receiving/transmitting device 24 and the first wireless receiving/transmitting device 14 so that the information of the separable device 2 can be synchronized with respect to that of the carrier body 1 or alternatively, they can be used as walkie-talkie. Further, the separable device 2 may be used to perform communication or network connection through the wireless communication module 17 of the carrier body 1 so that the use is made more convenient and the separable device 2 can omit certain components, such as network antenna, and can save some power. Further, the wireless communication module 17 of the carrier body 1 may serve as a base station for an electronic device 4 (such as a tablet computer) to establish wireless connection and transmit information. Further, the second transmission device 25 of the separable device 2 can be connected to a charger 5 to receive direct charging therefrom (as shown in FIG. 4).

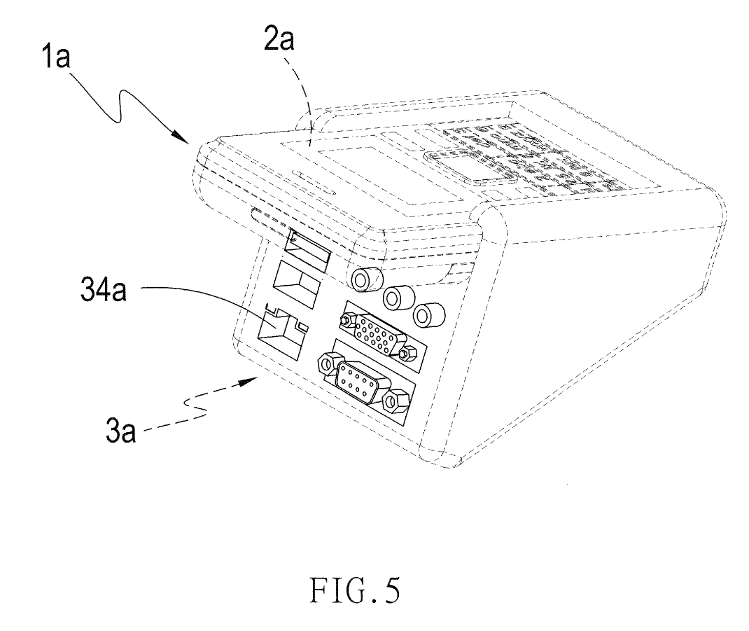

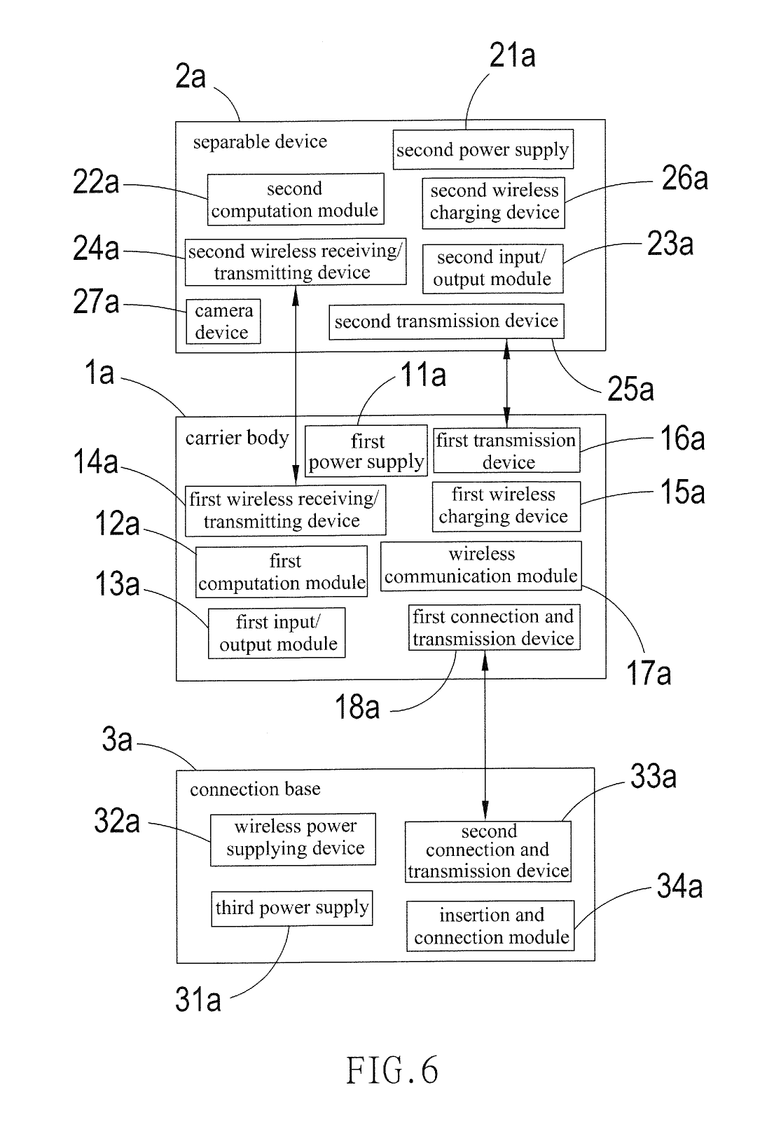

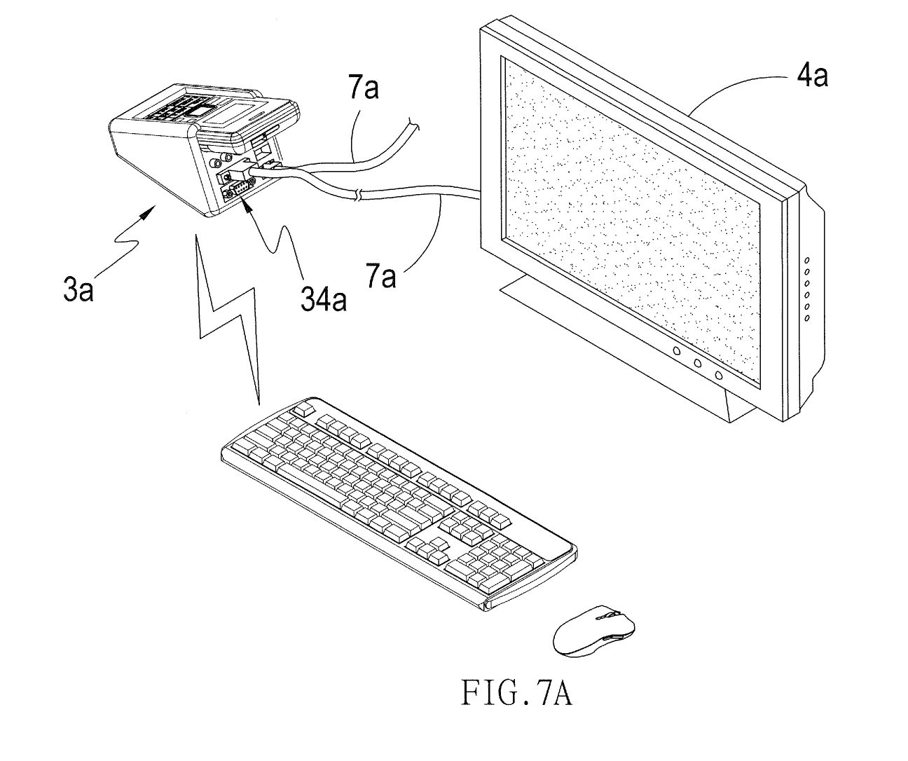

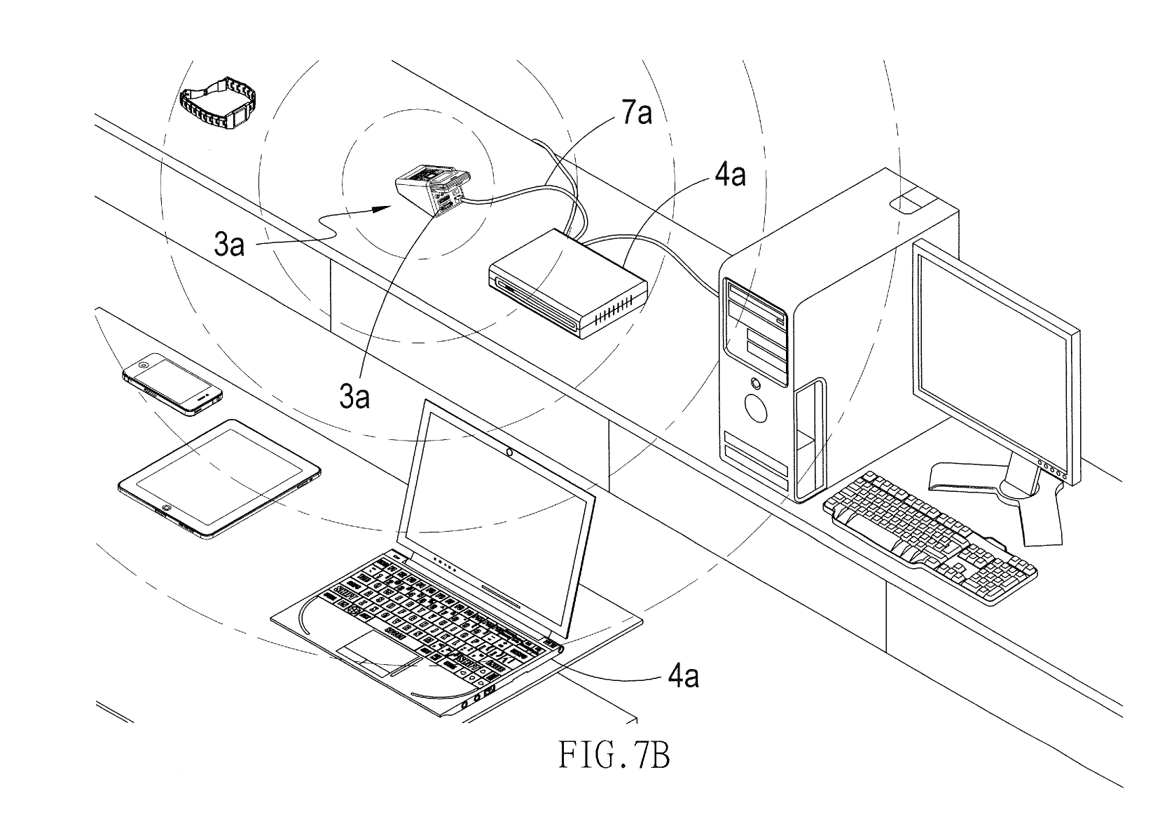

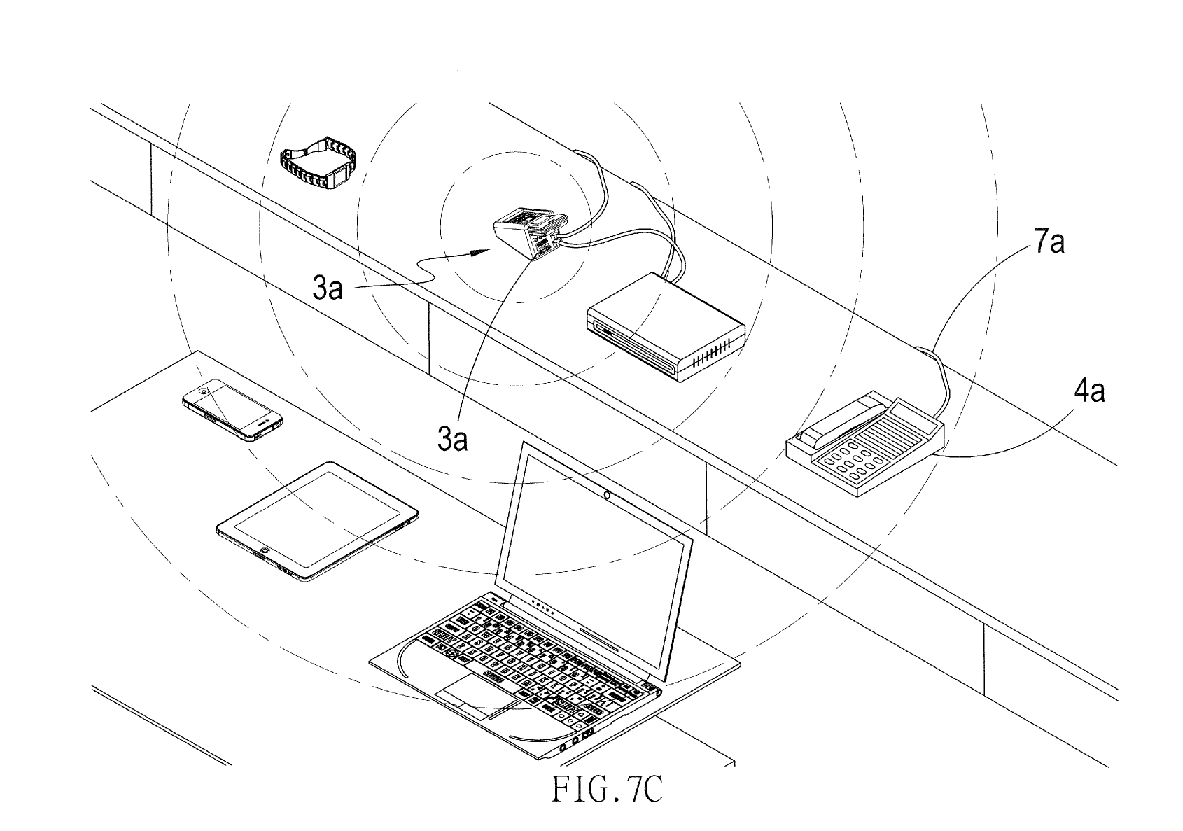

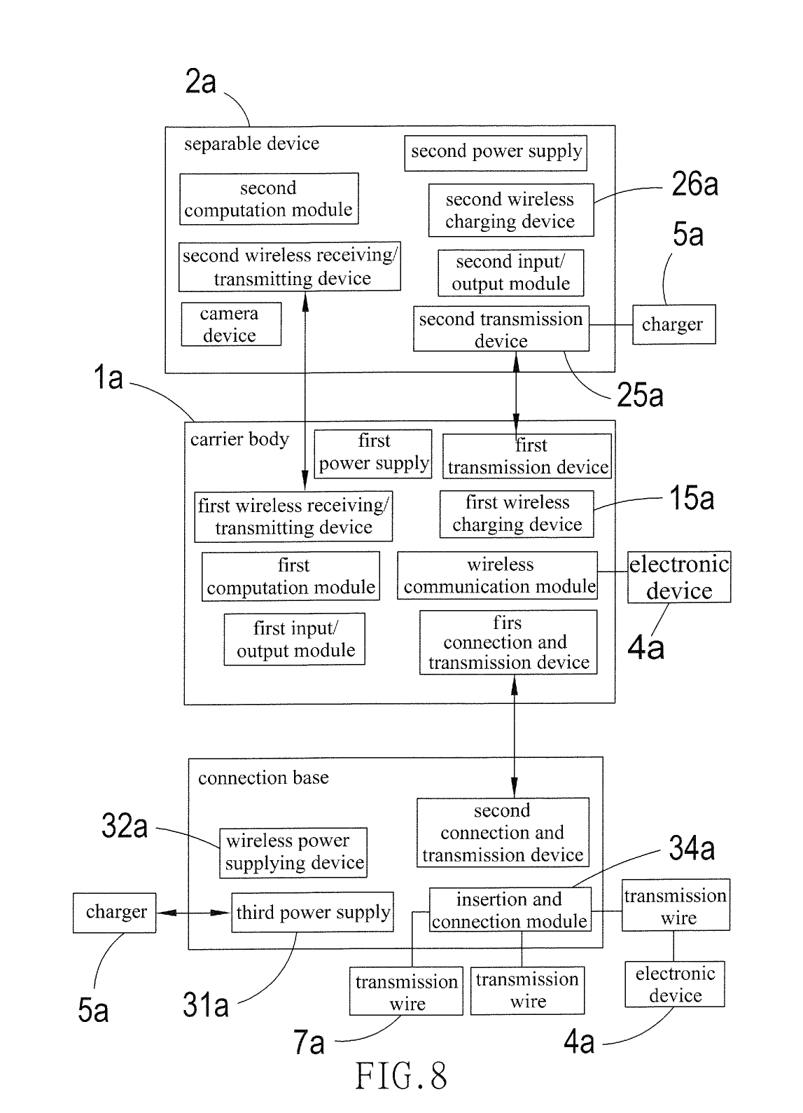

Referring to FIGS. 5-8, which are respectively a perspective view and a block diagram of another preferred embodiment of the present invention, perspective views showing three ways of use of the preferred embodiment of the present invention, and a block diagram showing a use of the preferred embodiment of the present invention, these drawings clearly show that the present invention comprises a carrier body 1a and a separable device 2a. The carrier body 1a comprises a first power supply 11a, a first computation module 12a connected to the first power supply 11a, a first input/output module 13a connected to the first power supply 11a, a first wireless receiving/transmitting device 14a connected to the first power supply 11a, a first wireless charging device 15a connected to the first power supply 11a, a first transmission device 16a connected to the first power supply 11a, and a wireless communication module 17a connected to the first power supply 11a. The separable device 2a comprises a second power supply 21a, a second computation module 22a connected to the second power supply 21a, a second input/output module 23a connected to the second power supply 21a, a second wireless receiving/transmitting device 24a connected to the second power supply 21a, a second transmission device 25a connected to the second power supply 21a, a second wireless charging device 26a connected to the second power supply 21a, and a camera device 27a connected to the second power supply 21a. The separable device 2a is selectively mountable to the carrier body 1a.

A difference from the previously described embodiment is that in the instant embodiment, the present invention further comprises a connection base 3a to which the carrier body 1a is selectively mounted. The connection base 3a comprises a third power supply 31a, a wireless power supplying device 32a connected to the third power supply 31a, a second connection and transmission device 33a connected to the third power supply 31a, and an insertion and connection module 34a connected to the third power supply 31a. A first connection and transmission device 18a of the carrier body 1a is selectively engageable with the second connection and transmission device 33a. In the use of the present invention, the wireless power supplying device 32a is set in electrical connection with the first wireless charging device 15a and the second wireless charging device 26a in a wireless manner in order to charge them. The third power supply 31a or the second transmission device 25a is connectable with a charger 5a to receive direct charging therefrom. Further, the insertion and connection module 34a is connectable with at least one transmission wire 7a to establish wired connection and information transmission with at least one electronic device 4a (such as an fixed-network phone, a modem, or a television set) and further, mutual information transmission can be made be through the wireless communication module 17a and the transmission wire 7a, so that the present invention may achieves the purposes of watching or helping broadcasting network TV programs or dialing the fixed-network phone and wireless applications.

The technical features that the separable mobile communication device and method according to the present invention can improve the prior art drawbacks are as follows:

(1) Through the collaborative arrangement of the carrier body 1 and the separable device 2, the present invention allows for the devices be separated for use and transmission of information as individual devices.

(2) Through the collaborative arrangement of the carrier body 1 and the separable device 2, the present invention allows for free, convenient, and versatile ways of use and carrying.

(3) Through the collaborative arrangement of the carrier body 1a, the separable device 2a, and the connection base 3a, the present invention allows for integrated use with an electronic device 4a.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A separable mobile communication method, comprising the following steps: when a separable device is separated from a carrier body, a second wireless receiving/transmitting device of the separable device establishing wireless information connection with a first wireless receiving/transmitting device of the carrier body, and the carrier body comprising a wireless communication module for communication or network connection, so that under the condition of being separated from the carrier body, the separable device is allowed to perform communication or network connection and saves energy consumption of the separable device.

2. The separable mobile communication method according to claim 1, wherein the carrier body further comprises a first power supply connected to the first wireless receiving/transmitting device and wireless communication module, a first computation module connected to the first power supply, a first input/output module connected to the first power supply, a first wireless charging device connected to the first power supply, and a first transmission device connected to the first power supply; and the separable device is selectively mountable to the carrier body and comprises a second power supply connected to the second wireless receiving/transmitting device, a second computation module connected to the second power supply, a second input/output module connected to the second power supply, a second transmission device connected to the second power supply, a second wireless charging device connected to the second power supply, and a camera device connected to the second power supply, the second transmission device and the first transmission device being selectively engageable with and thus connectable to each other, the second wireless receiving/transmitting device and the first wireless receiving/transmitting device being in wireless information connection with each other.

3. The separable mobile communication method according to claim 2, wherein the first wireless charging device is in wireless connection with and electrically charges the second wireless charging device, the second transmission device being connectable to a charger to receive direct charging therefrom, the wireless communication module selectively serving as a base station.

4. The separable mobile communication method according to claim 2, wherein the first input/output module and the second input/output module are each one of a touch screen, a touch keypad, a screen, and a keypad or a combination of at least two of them.

5. The separable mobile communication method according to claim 2, wherein when the carrier body is mounted to a connection base, a first connection and transmission device of the carrier body is in set in engagement and connection with a second connection and transmission device of the connection base, the first connection and transmission device being connected to the first power supply, the carrier body comprising an insertion and connection module for connection with at least one transmission wire to allow the connection base to establish wired connection.

6. The separable mobile communication method according to claim 5, wherein the connection base further comprises a third power supply connected to the second connection and transmission device and the insertion and connection module and a wireless power supplying device connected to the third power supply.

7. The separable mobile communication method according to claim 6, wherein the wireless power supplying device is in connection with the first wireless charging device and the second wireless charging device in a wireless manner in order to charge them, the third power supply being connectable with the charger to receive direct charging therefrom, the insertion and connection module being connectable with at least one transmission wire for wired connection.
